(19) United States
(12) Patent Application Publication
(10) Pub. No.: US 2006/0263143 A1
(43) Pub. Date: Nov. 23, 2006

(54) Multifunctional marking device

(76) Inventors: Chinchen Tseng, Diamond Bar, CA (US); Kuo Ye Tseng, Diamond Bar, CA (US); Louis Kuolong Tseng, Diamond Bar, CA (US)

Correspondence Address: KAPLAN GILMAN GIBSON & DERNIER L.L.P., 900 ROUTE 9 NORTH, WOODBRIDGE, NJ, 07095, US

(21) Appl. No.: 11/132,704

(22) Filed: May 19, 2005

(51) Int. Cl. B43K 29/00; B43K 5/00

(52) U.S. Cl. 401/195; 401/202

(57) ABSTRACT

A multifunctional marking device comprises one or two types of markers and a fastener for facilitating closure of button-secure tags. In particular, the fastener comprises a recess provided at one end of the device or a cap of the markers. Preferably, the marking device comprises both a writing instrument such as a pen and a stylus with a metal point to meet a need for making different types of markings.

### BACKGROUND OF THE INVENTION

This invention relates to a marking device, and more particularly, to a multifunctional marking device that can put marks on a surface such as a tag, and can facilitate closure of button-secure tags as well.

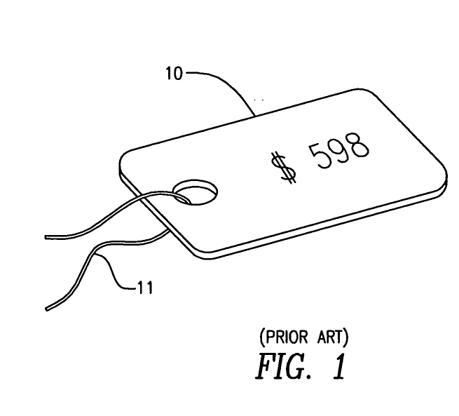

A tag is used to indicate identification information such as price, name, model number, etc., of an item (such as a jewelry item) to which the tag is attached. FIG. 1 illustrates a tag 10 that is attachable to an item by a proper thread or wire 11. Information such as price is put on one or both sides of the tag 10 by a marking device. The marking device may be a regular writing instrument, such as a pen or pencil, which is often used to put markings on most tags. To make a permanent marking, usually a stylus is used by scrubbing off a thin coat of paint on a tag with a hard metal point of the stylus. Thus, a user has to find different types of marking devices to make desired types of markings, which is very inconvenient.

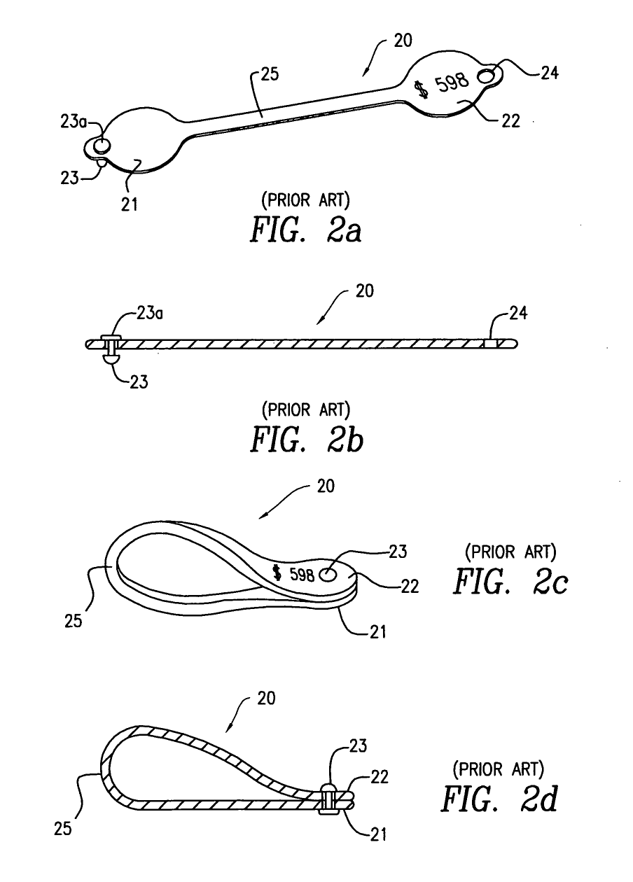

FIGS. 2a-2d illustrate a button-secure tag 20 that is often used for tagging items for sale, such as, but not limited to, jewelry. The button-secure tag 20 is made of a flexible material such as plastic and comprises two end portions 21 and 22 connected by a bridge portion 25. The two end portions 21 and 22 are relatively large and therefore suitable to bear markings thereon. As best seen in FIGS. 2c and 2d, when attaching the tag 20 to an item (not shown), one of the two end portions 21 and 22 (after passing a proper hole in a jewelry item, not shown) is brought to the other to form a loop by folding the tag 20 at the elongate bridge portion 25. To close the loop of the tag 20, a button 23 having a semispherical head provided on the end portion 23 is forced through a hole provided in the end portion 22, as best seen in FIGS. 2c and 2d. However, it is very inconvenient and awkward to force the button 23 into the hole 24 by fingers of a hand since the tag 20 is usually quite small.

Therefore, there exists a need for a marking device that can be used to make different types of markings, and preferably can help closing button-secure tags, thus eliminating the inconvenience in the prior art.

### SUMMARY OF THE INVENTION

The object of the present invention is to provide a multifunctional marker that can be used to make different types of markings.

Another object of the present invention is to provide a marker that is capable of facilitating closure of a button-secure tag.

The present invention provides a device which comprises a marker for making markings on a tag, and a fastener for facilitating closure of a button-secure tag. Thus, a user can conveniently use a single device to make markings on the tag and to close the tag as well.

Preferably, the marker comprises both a writing instrument and a stylus, and therefore can be conveniently used to make different types of markings.

Preferably, the fastener comprises a recess for accepting a button of the button-secure tag when the button is forced through a hole in the tag.

In an embodiment, the fastener is provided in an end surface of a cap of the marker. In another embodiment, the fastener is formed by an end portion of the marker opposite to a marking point of the marker.

### DETAILED DESCRIPTION OF THE DRAWINGS

The above and other features and advantages will be clearer after reading the detailed description of the preferred embodiments of the present invention with reference to the accompanying drawings, in which:

FIG. 1 illustrates a conventional regular tag;

FIG. 2a is a perspective view illustrating a conventional button-secure tag;

FIG. 2b is a sectional view illustrating the button-secure tag in FIG. 2a;

FIG. 2c is a perspective view illustrating the button-secure tag in FIGS. 2a-2b in a folded state;

FIG. 2d is a sectional view of the button-secure tag in FIG. 2c.

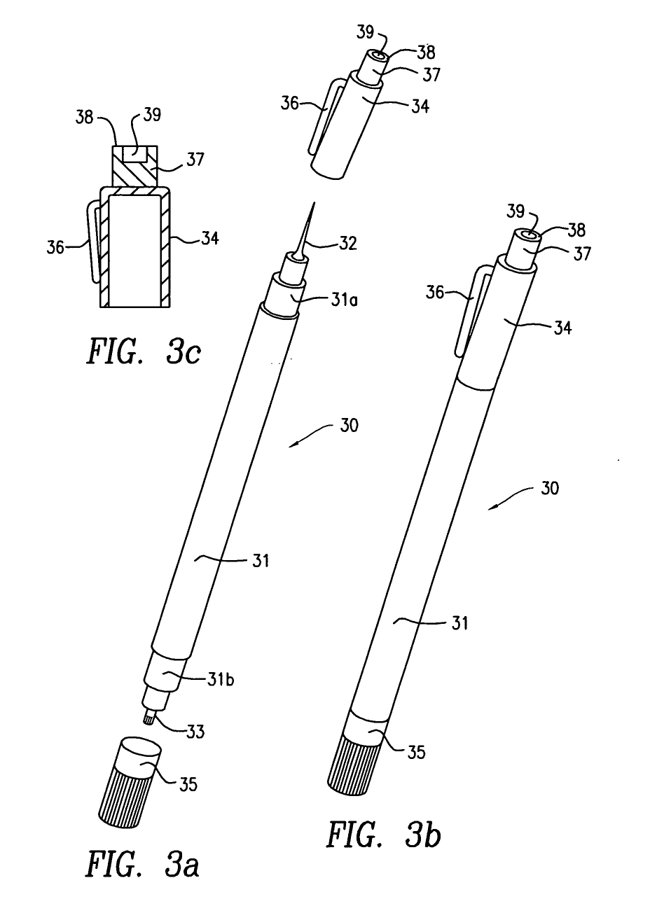

FIG. 3a is a perspective view illustrating a first embodiment of the multifunctional marking device according to the present invention, with the caps detached;

FIG. 3b illustrates the marking device of FIG. 3b, with the caps in place;

FIG. 3c is a sectional view of a cap in FIGS. 3a and 3b;

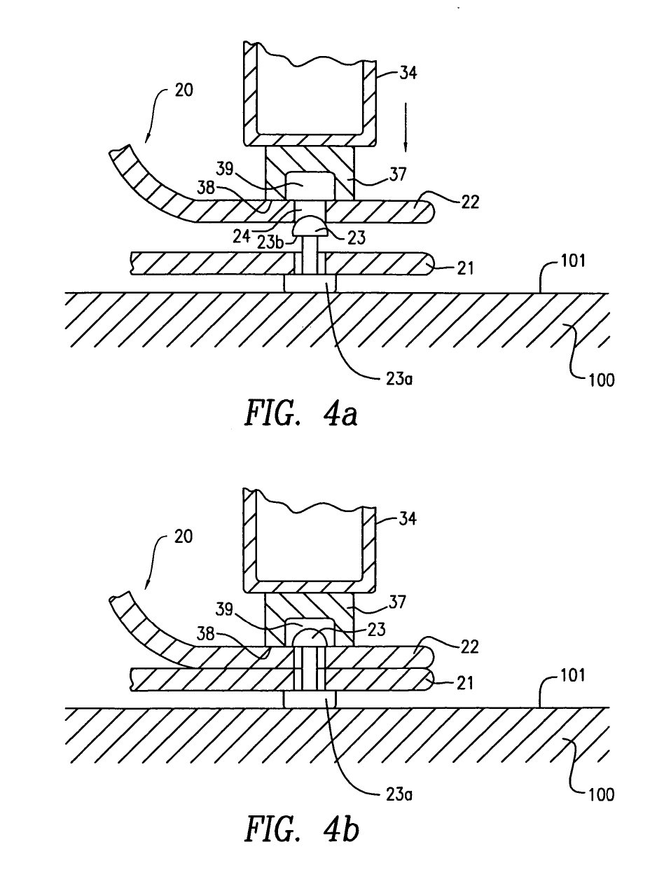

FIGS. 4a and 4b are sectional views illustrating how the multifunctional marking device in FIGS. 3a-3c works to close a button-secure tag;

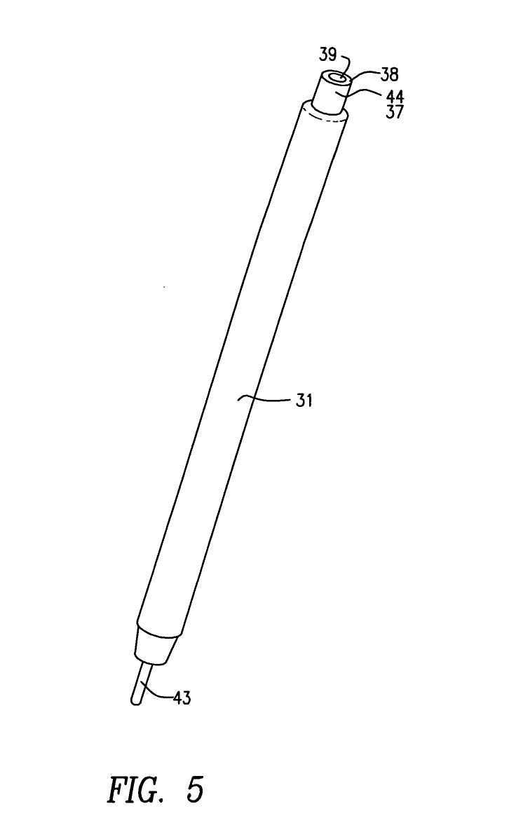

FIG. 5 illustrates another embodiment of a multifunctional marking device according to the present invention.

### DETAILED DESCRIPTION OF PREFERRED EMBODIMENTS

A preferred embodiment of a multifunctional marking device 30 according to the present invention is illustrated in FIGS. 3a and 3b. The multifunctional marking device 30 generally comprises an elongate body portion 31 with two opposite end portions 31a and 31b. According to the teaching of the present invention, a stylus 32, which may be made of a hard metal material such as steel, is provided at end portion 31a, and a regular writing instrument 33, such as a pen, pencil or marker, is provided at the opposite end portion 31b.

Caps 34 and 35 are provided for covering the stylus 32 and the writing instrument 33 respectively when they are not in use. The end portions 31a, 31b are slightly smaller than the body portion 31 so that the outer surfaces of the caps 34, 35 form substantially continuous extensions from the body portion 31 when they are in place on the end portions 31a, 31b to cover the stylus 31 and the writing instrument 33.

The cap 34 comprises an end portion 37 having an end surface 38. According to the teaching of the present invention, a recess 39 (best seen in FIG. 3c) is provided in the end surface 38, which works as a fastener means for facilitating closure of a button-secure tag, as explained in detail with FIGS. 4a and 4b below. The cap 34 may further comprise a clip 36 for attaching the marking device 30 to an external item, e.g., a pocket of a shirt.

FIGS. 4a and 4b schematically illustrate how the recess 39 works to close the button-secure tag 20. To make a closed loop, the tag 20 is folded at the bridge portion 25 (also see FIGS. 2c and 2d) so that the end portion 21 is brought underneath the end portion 22, with the button 23 located at the entrance of the hole 24 in the end portion 22. The button 23 is generally semispherical in shape, and is slightly larger than the hole 24 in size. The tag 20 is then placed on a surface 101, e.g., of a table 100, with a flat end 23a of the button 23 resting on the surface 101. The cap 34 is placed on the end portion 22, with the end surface 38 pressing on the end portion 22 and with the recess 39 right above the hole 24. Then, as shown by the arrow of FIG. 4a, the cap 34 is pressed down on the end portion 22 forcing the semispherical button 23 to enter the hole 24 and pass through the hole 24. The button 23 is accepted in the recess 39, which allows the button 23 to pass through the hole 24 freely without any obstruction. The flat bottom 23b, which is slightly larger than the hole 24, prevents the button 23 from reentering the hole 24 thereby connecting the end portions 21 and 22 with each other to form a closed loop.

Preferably, the recess 39 is located at the center of the end surface 38 so that a user can easily put the recess 39 right above the hole 24, ready to accept the button 23.

Thus, it is seen that in a preferred embodiment multifunctional writing device 30 can perform 3 distinct operations: (1) marking a standard type label with writing instrument 33; (2) marking a metal or plastic tag with stylus 32; and (3) securing together the ends of a button-secure tag with fastener 37.

FIG. 5 illustrates another embodiment of the multifunctional marking device according to the present invention. In this embodiment, the marking device comprises a marker 43 at one end of an elongated body 31. The marker 43 is illustrated as a writing instrument such as a pen or pencil. Alternatively, the marker 43 may be a stylus.

An end portion 44 is provided at the other end of the elongated body 31 opposite to the marker 43. According to the teaching of the present invention, a recess 39 is provided in an end surface 38 of the end portion 37 for facilitating closure of a button-secure tag, similar to the previous embodiment as shown in FIGS. 4a and 4b.

Preferably, the end portion 37 is a plunger for driving the marking point of the marker 43 between an exposed working position as shown in FIG. 5 and a retracted position in which the marker 43 rests inside the body 31.

Alternatively, marker 43 of the embodiment of FIG. 5 may be a stylus 43.

Though the above has described the preferred embodiment of the present invention, it shall be understood that numerous adaptations, modifications and variations are possible to those skilled in the art without departing the gist of the present invention. For example, like the cap 34, the cap 35 in FIGS. 3a and 3b can also be provided with a recess 39 in its end surface. The recess 39 may be provided at a side surface of the body 31 or the caps 34, 35 as well. The shape of the recess 39 does not need to be circular, but can be any desired shape, as long as it is large enough to accept the button 23. The marker 33, 34 and 43 can be any types of writing instruments that can be used to write on a tag, such as an ink pen, ball pen, pencil, crayon, highlighter, etc., or any types of styluses with a hard point for making permanent markings by scrubbing off the paint on the tag or by carving/scraping on the tag with a hard point.

It will thus be seen that the objects set forth above, among those made apparent from the preceding description, are efficiently attained, and since certain changes may be made in the above constructions without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention, which, as a matter of language, might be said to fall therebetween.

What is claimed is:

1. A device comprising:
a marker; and
a fastener for facilitating closure of a button-secure tag.

2. The device of claim 1, wherein said fastener comprises a recess for accepting a button of the tag when the button is forced through a hole in the tag.

3. The device of claim 2, wherein said fastener comprises a substantially flat surface, in which said recess is formed.

4. The device of claim 3, wherein said flat surface is an end surface of the marker opposite to a point of said marker.

5. The device of claim 2, wherein said flat surface is an end surface of a cap for covering said point of said marker.

6. The device of claim 1, wherein said marker comprises a writing instrument.

7. The device of claim 5, wherein said writing instrument is a pen.

8. The device of claim 1, wherein said marker comprises a stylus.

9. The device of claim 1, wherein said marker comprises both a writing instrument and a stylus.

10. The device of claim 8, wherein said writing instrument and said stylus are provided at opposite ends of an elongate body of said marker.

11. The device of claim 9, wherein said marker is provided with two caps for covering said writing instrument and said stylus, and at least one of said caps is provided with said recess for accepting said button of said tag.

12. A multifunctional marking instrument comprising:
an elongated body provided with two different markers at opposite ends, and
at least one cap having an end surface provided with a recess for accepting a button of a button-secure tag so as to facilitate forcing said button through a hole in the tag.

13. The marking instrument of claim 12, wherein one of said markers is a writing instrument, while the other is a stylus.
